(19) United States
(12) Patent Application Publication
(10) Pub. No.: US 2009/0097696 A1
(43) Pub. Date: Apr. 16, 2009

(54) System and method of dynamic insertion of data

(75) Inventors: Aaron Knoll, Hollsville, NY (US); Jennifer Kelliher, Bellport, NY (US)

Correspondence Address: Stephen E. Feldman, 7th FL, 12 E. 41st Street, New York, NY, 10017, US

(73) Assignee: Protocall Technologies

(21) Appl. No.: 11/521,125

(22) Filed: Sep. 14, 2006

Related U.S. Application Data
(60) Provisional application No. 60/716,837, filed on Sep. 14, 2005.

(51) Int. Cl. G06K 9/00

(52) U.S. Cl. 382/100

(57) ABSTRACT

Utilization of the on-demand/one-off digital content manufacturing process can be used to create a unique digital product that includes additional content targeted to the consumer. Through applying advanced analytical and artificial intelligence technology to data gathered at time of purchase, material that best matches the consumer's interests can be selected. Once additional data is selected it can be altered with tracking information and then inserted to create the consumer's final product.

### CROSS-REFERENCE TO RELATED APPLICATIONS

This application is based upon and hereby claims priority to U.S. Provisional Patent Ser. No. 60/716,837 filed Sep. 14, 2005 and entitled System and Method for Dynamic Insertion of Data, hereby incorporated by reference.

### BACKGROUND OF THE INVENTION

There is constant need for companies to expose their products to consumers in hopes of increasing sales. By allowing advertisers to more effectively address their target audience, advertisers are able to bring more compelling ads to their potential customers. Currently digital products such as DVD movies and Audio CDs do have the ability to include additional material such as movie trailers, and bonus audio tracks. However, the nature of the production and sale of pre-produced Digital Media not only limits the ability to gather important purchasing data for targeting this additional material but, it also makes it impossible to insert the unique targeted material on these products.

### FIELD OF THE INVENTION

This invention relates generally to dynamic insertion of additional material into digital content. Moreover, it pertains specifically to the ability to insert additional materials (i.e. Shareware, Movie Trailers) that have been targeted to the individual consumer, into digital content that is delivered via Digital Media or internet download.

### BRIEF SUMMARY OF THE INVENTION

A principal object of the present invention is to provide various methods of insertion of selected additional data into digital products.

An object of the present invention is to provide a method to insert additional data into products stored on recordable Digital Media.

Another object of the present invention is to provide a method to insert selected data into digital products downloaded via the internet.

Another object of the present invention is to provide a method of targeted marketing which is not apparent, obvious, or suggested, either directly or indirectly by any of the prior art.

Another object of the present invention is provide a method for gathering, compiling and analyzing data that would identify the best match between potential additional material and the consumer.

Another object of the present invention is to allow advertising to be targeted to individual consumers.

Another object of the present invention is to provide a method of tracking data inserted through present invention methodology.

Another object of the present invention is that files can be serialized such that, if the advertiser requires and the file type supports it, communication can be initiated with a server on the internet and the file can be tracked.

Another object of the present invention is to allow retailers/publishers to advertise on physical media by inserting digital files directly into the finished product dynamically.

It is intended that any other advantages and objects of the present invention that become apparent or obvious from the detailed description or illustrations contained herein are within the scope of the present invention.

### BRIEF DESCRIPTION OF THE DRAWINGS

FIG. 1 is a flow diagram showing a multi-step process for the present invention;

FIG. 2 is a flow diagram showing a multi-step process for the present invention using pre-mastered ISO files; and

FIG. 3 is a flow diagram showing a multi-step process for the present invention using dynamically recorded digital media.

### DETAILED DESCRIPTION OF THE INVENTION

The present invention utilizes the on-demand/one-off digital content manufacturing process to create a unique digital product that includes additional content that has been targeted to the individual consumer. Through applying advanced analytical technology to both data gathered at time of purchase and situational demographics, material that best matches the consumer's interests can be selected. Once additional data is selected it can be “tagged” with tracking information and then inserted into the final product.

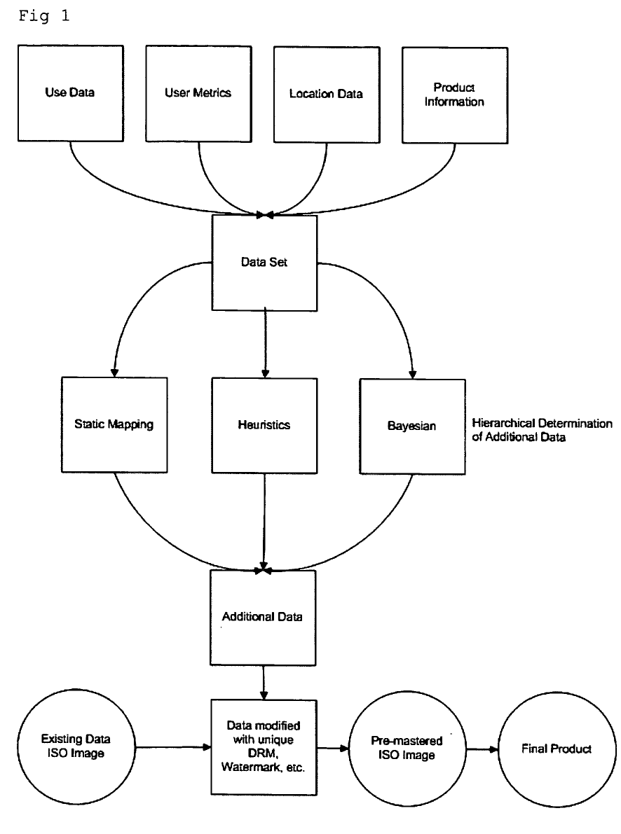

The following multi-step process is use to facilitate the ability to create a unique digital product by insertion of targeted additional content. (See FIG. 1)

STEP 1: At the time of purchase several pieces of information can be obtained.
a. Usage Data—As the consumer navigates the user interface information about their activities such as what other products were view can be recorded.
b. Consumer Metrics—Depending on the situation, Metrics can be gathered that range from simple area demographics to sampled biometric data.
c. Location Data—Information about the geographic location of where the purchase is taking place.
d. Product Information—Information about the product(s) such as the product genre,

STEP 2: All the information is organized into a logic data set which is then evaluated using the following two methods.
a. Heuristic Evaluation
b. Bayesian Analysis

This information plus the static mapping information, containing predetermined criteria, is used to select the best material for insertion.

STEP 3: Once the data to be inserted has been selected any combination of serial numbers or Digital Watermarks can be embedded into that data so long as the data type supports it. Moreover, for data types such as Computer Programs or Audio/Video data protected by a Digital Rights Management (DRM) scheme, an industry-standard “phone home” setup can be enabled which will cause the additional data to report its use and whereabouts back to the content provider.

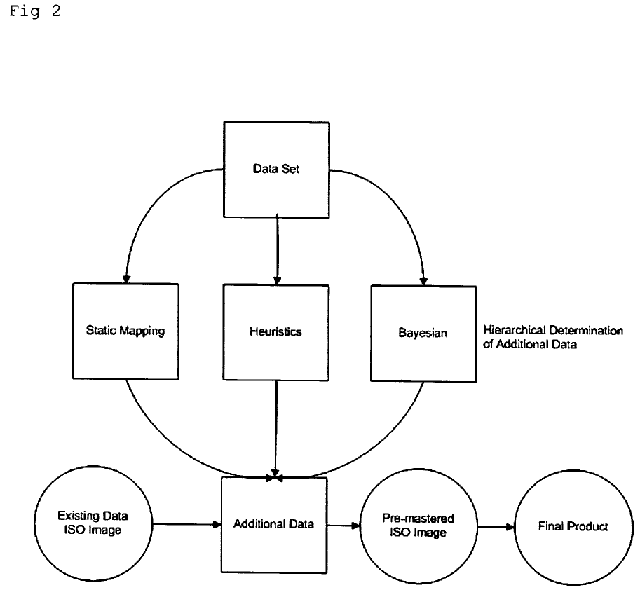

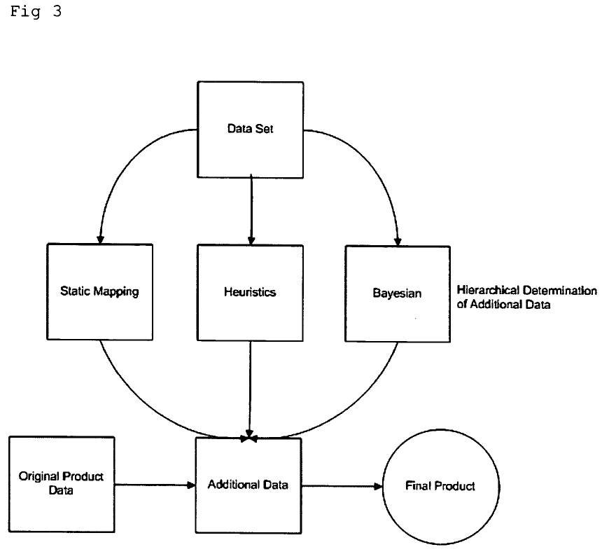

STEP 4: The additional content is either inserted onto a Digital Media product or delivered via internet download. There are two methods by which the additional content can be inserted onto a Digital Media.
a) The original product is stored as an ISO image. The ISO image is a file-based representation of the structure of a CD/DVD. Additional content can be added in a specific location by altering this file and its structure to create a new pre-mastered ISO image file. This pre-mastered ISO image is recorded to disc. (See FIG. 2)
b) If an ISO file doesn't exist and the Digital Media is being created “on-the-fly”, additional content can be inserted into the data stream being recorded. This method is limited to CD Audio and Software that doesn't require any specific copy-protection. (See FIG. 3)

If the content is obtained by internet download there are two methods for delivering the targeted content:
a) The additional content can be inserted into the download “package” or directly into the download datastream.
b) The additional content can be delivered later via e-mail.

It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

What is claimed is:

1. A method for specifying additional content that will be inserted into a digital content product at the time of production comprising the steps of:
(a) collecting data, said data including usage data, consumer metrics, location data, and specific product information;
(b) analyzing said data;
(c) selecting additional content based on the analyzed data;
(d) embedding a unique watermark into the additional content; and
(e) inserting the additional data onto the digital content product.

2. The method of claim 1 further comprising the step of:
(a) utilizing a static mapping between the digital content product and the additional content.

3. The method of claim 1 wherein the additional content is selected using a heuristic analysis of the data.

4. The method of claim 1 wherein the additional content is selected using a Bayesian analysis of the data.

7. The method of claim 1 wherein the additional content is inserted into a data stream of the digital content product.

8. The method of claim 7 wherein the digital content product is created on optical media such as CD-ROM, DVD, BluRay, or any other optical media type.

9. The method of claim 7 wherein the digital content product is created on a solid state memory device.

10. The method of claim 7 wherein the digital content product is created directly on a portable device.

11. The method of claim 7 wherein the Digital Media Product is created for download to a computer.

12. A system for specifying additional content that will be inserted into a digital content product at the time of production comprising:
(a) collecting means for collecting data, said data including usage data, consumer metrics, location data, and specific product information;
(b) analyzing means for analyzing said data;
(c) selecting means for selecting additional content based on the analyzed data;
(d) embedding means for embedding a unique watermark into the additional content; and
(e) inserting means for inserting the additional data onto the digital content product
